(19) United States
(12) Patent Application Publication
(10) Pub. No.: US 2015/0186592 A1
(43) Pub. Date: Jul. 2, 2015

(54) METHOD FOR DESIGNING PHOTOMASK AND COMPUTER READABLE RECORDING MEDIUM RECORDED WITH PHOTOMASK DESIGN PROGRAM

(71) Applicant: SAMSUNG DISPLAY CO., LTD., Yongin-City (KR)

(72) Inventor: Woo Jung Shin, Osan-si (KR)

(21) Appl. No.: 14/326,445

(22) Filed: Jul. 8, 2014

(30) Foreign Application Priority Data
Jan. 2, 2014 (KR) 10-2014-0000267

(51) Int. Cl. G06F 17/50

(52) U.S. Cl. CPC G06F 17/5081

(57) ABSTRACT

A method for designing a photomask includes preparing mask layout data including first pattern data and second pattern data, the first pattern data including shape information of a design pattern, and the second pattern data including the shape information of the design pattern and array information, assigning a first photoshoot region to the mask layout data, and when the first photoshoot region overlaps the second pattern data, determining whether or not the first photoshoot region overlaps the second pattern data and reconstructing the second pattern data according to a boundary of the first photoshoot region.

### CROSS-REFERENCE TO RELATED APPLICATION

This application claims priority to and the benefit of Korean Patent Application No. 10-2014-0000267, filed on Jan. 2, 2014 in the Korean Intellectual Property Office, the disclosure of which is incorporated herein in its entirety by reference.

### BACKGROUND

1. Field

Aspects of embodiments of the present invention are directed toward a method for designing a photomask and a computer-readable recording medium recorded with a photomask design program.

2. Description of the Related Art

In order to manufacture a photomask that is used (utilized) in or during an exposing process for forming a specific pattern on a panel, mask layout data that is the basis of the photomask is utilized. As patterns that are formed on a panel become more precise and the number of patterns is geometrically increased, various attempts to reduce the amount of photomask layout data have been made.

One such attempt is by utilizing a stitch method. In the case of mask layout data that is designed utilizing the stitch method, it is difficult to directly compare a pattern that is actually formed on a panel with the mask layout data, and thus, it is difficult to find a design defect in the design process. Accordingly, there is a need for a method for comparing the mask layout data that is designed utilizing the stitch method with the pattern that is actually formed on the panel.

### SUMMARY

Accordingly, one aspect of embodiments of the present invention is to provide a method for designing a photomask which can compare mask layout data with a pattern that is actually formed on a panel.

Another aspect of embodiments of the present invention is to provide a method for designing a photomask which can find a design defect in advance (e.g., in a design stage) and can take corresponding measures (e.g., corrective measures) through reconstruction of mask layout data on the basis of a photoshoot.

Still another aspect of embodiments of the present invention is to provide a computer-readable recording medium storing (e.g., recorded with) a photomask design program including a method for designing a photomask which can compare mask layout data with a pattern that is actually formed on a panel.

Still another aspect of embodiments of the present invention is to provide a computer-readable recording medium recorded with a photomask design program including a method for designing a photomask which can find a design defect in advance (e.g., in a design stage) and can take corresponding measures through reconstruction of mask layout data on the basis of a photoshoot.

Additional features and characteristics of embodiments of the invention will be set forth in part in the description which follows and in part will become apparent to those having ordinary skill in the art upon examination of the following or may be learned from practice of the invention.

According to an embodiment of the present invention, there is provided a method for designing a photomask including preparing mask layout data including first pattern data and second pattern data, the first pattern data including shape information of a design pattern, and the second pattern data including the shape information of the design pattern and array information, assigning a first photoshoot region to the mask layout data, determining whether or not the first photoshoot region overlaps the second pattern data and, when the first photoshoot region overlaps the second pattern data, reconstructing the second pattern data according to a boundary of the first photoshoot region.

According to another embodiment of the present invention, there is provided a method for designing a photomask including assigning a first photoshoot region and a second photoshoot region to mask layout data, the mask layout data including first pattern data and second pattern data, determining whether or not the first photoshoot region overlaps the second pattern data, when the first photoshoot region overlaps the second pattern data, reconstructing array information of the second pattern data according to a boundary of the first photoshoot region, determining whether or not the second photoshoot region overlaps the second pattern data and, when the boundary of the second photoshoot region overlaps the second pattern data, reconstructing the array information of the second pattern data according to a boundary of the second photoshoot region.

According to another embodiment of the present invention, there is provided a computer-readable recording medium storing a design program of a photomask, the design program being for causing a computer to perform a process and including assigning a first photoshoot region to mask layout data, the mask layout data including first pattern data and second pattern data, determining whether or not the first photoshoot region overlaps the second pattern data and, when the first photoshoot region overlaps the second pattern data, reconstructing the second pattern data according to a boundary of the first photoshoot region.

According to another embodiment of the present invention, there is provided a computer-readable recording medium storing a design program of a photomask, the design program being for causing a computer to perform a process including assigning a first photoshoot region and a second photoshoot region to mask layout data, the mask layout data including first pattern data and second pattern data, determining whether or not the first photoshoot region overlaps the second pattern data, when the first photoshoot region overlaps the second pattern data, reconstructing array information of the second pattern data according to a boundary of the first photoshoot region, determining whether or not the second photoshoot region overlaps the second pattern data and, when the second photoshoot region overlaps the second pattern data, reconstructing the array information of the second pattern data according to a boundary of the second photoshoot region.

According to aspects of embodiments of the present invention, at least the following effects can be achieved.

That is, the mask layout data that is designed utilizing the stitch method can be compared with the pattern that is actually formed on the panel.

Further, because the mask layout data can be reconstructed on the basis of the photoshoot, any design defects can be found in advance (e.g., in the design stage) and the corresponding measures can be taken.

The aspects and features according to embodiments of the present invention are not limited to those described above and various additional aspects and features are described in the specification of the present invention.

### BRIEF DESCRIPTION OF THE DRAWINGS

The above and other features and characteristics of the present invention will be more apparent from the following detailed description taken in conjunction with the accompanying drawings, in which:

FIG. 1 is a flowchart of a method for designing a photomask according to an embodiment of the present invention;

FIG. 2 is a schematic view of example mask layout data illustrating a method for designing a photomask according to an embodiment of the present invention;

FIG. 3 is a partial enlarged view of FIG. 2;

FIG. 4 is a schematic view of reconstructed second pattern data shown in FIG. 3;

FIG. 5 is a flowchart of a method for designing a photomask according to another embodiment of the present invention;

FIG. 6 is a schematic view of mask layout data that is used in a method for designing a photomask according to the embodiment shown in FIG. 5;

FIG. 7 is a partial enlarged view of FIG. 6;

FIG. 8 is a partial enlarged view of FIG. 6;

FIG. 9 is a schematic view illustrating a pattern that is actually formed on a panel on the basis of the mask layout data illustrated in FIG. 6;

FIG. 10 is a schematic view of reconstructed second pattern data shown in FIG. 8 to match a boundary of a first photoshoot region;

FIG. 11 is a schematic view of reconstructed second pattern data shown in FIG. 8 to match a boundary of a second photoshoot region;

FIG. 12 is a schematic view illustrating enumeration of pattern data of a first photoshoot region and pattern data of a second photoshoot region so that the respective pattern data does not overlap each other; and

FIG. 13 is a block diagram of a computer in a display according to an embodiment of the present invention.

### DETAILED DESCRIPTION

The aspects and features of embodiments of the present invention and methods for achieving the aspects and features will be apparent by referring to the embodiments to be described in detail with reference to the accompanying drawings. However, the present invention is not limited to the embodiments disclosed hereinafter and can be implemented in various forms. The matters defined in the description, such as the detailed construction and elements, are nothing but specific details provided to assist those of ordinary skill in the art in a comprehensive understanding of the invention. Various changes in form and details may be made therein without departing from the spirit and scope of the present invention as set forth in the appended claims and their equivalents.

The term “on” is used to designate that an element (layer) is on another element (layer) or located on one or more different elements (layers) includes both a case where the element is located directly on another element and a case where the element is located on another element via yet another element. In the entire description of the present invention, the same drawing reference numerals are used for the same elements across various figures.

Although the terms “first,” second,” and so forth are used to describe diverse constituent elements, such constituent elements are not limited by the terms. The terms are used only to discriminate a constituent element from other constituent elements. Accordingly, in the following description, a first constituent element may be a second constituent element and vice versa. Further, the use of “may” when describing embodiments of the present invention relates to “one or more embodiments of the present invention.”

Hereinafter, example embodiments of the present invention will be described in detail with reference to the accompanying drawings.

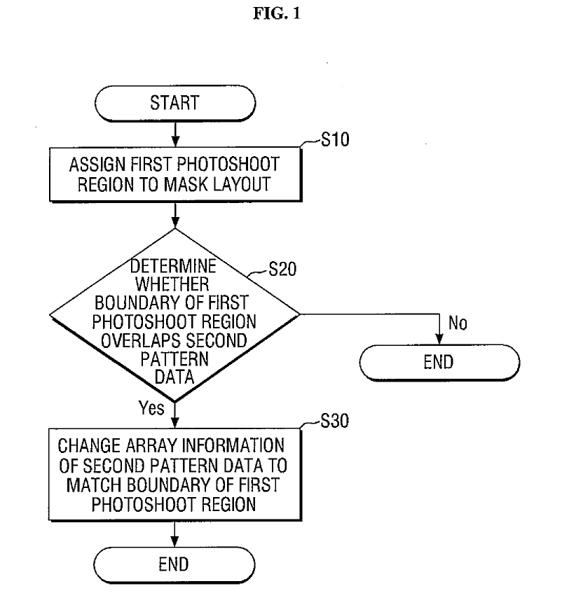

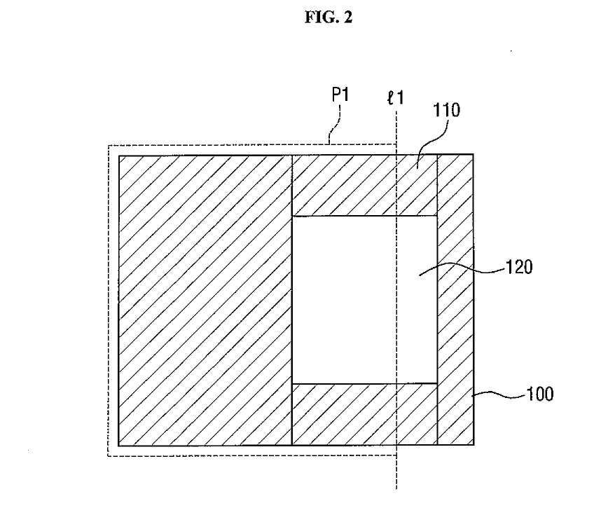

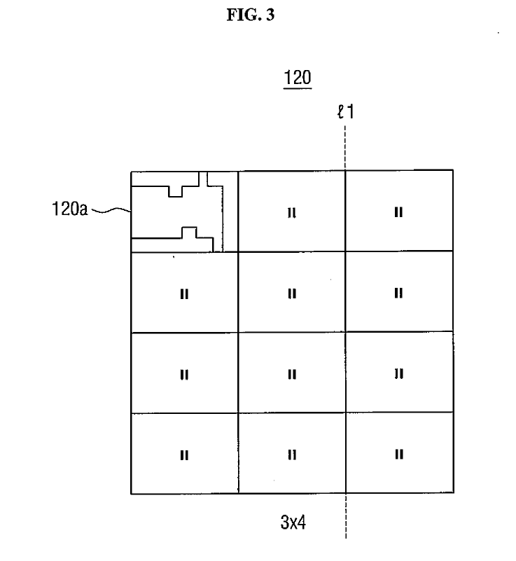

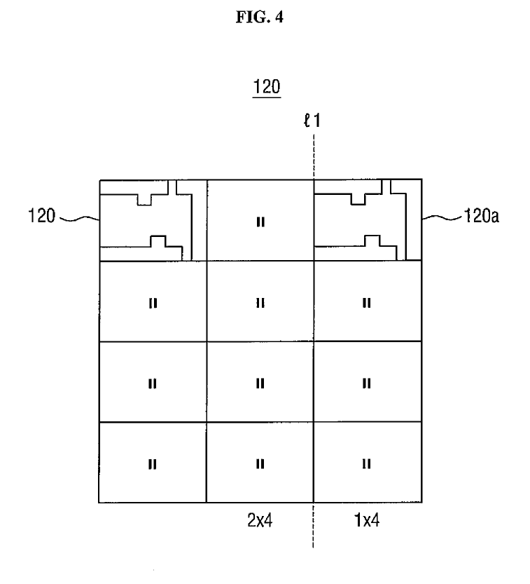

FIG. 1 is a flowchart of a method for designing a photomask according to an embodiment of the present invention. FIG. 2 is a schematic view of example mask layout data illustrating a method for designing a photomask according to an embodiment of the present invention, FIG. 3 is a partial enlarged view of FIG. 2, and FIG. 4 is a schematic view of reconstructed second pattern data shown in FIG. 3.

Referring to FIG. 1, a method for designing a photomask according to an embodiment of the present invention includes assigning a first photoshoot region to mask layout data that includes first pattern data and second pattern data, determining whether or not a boundary of the first photoshoot region overlaps the second pattern data, and reconstructing array information of the second pattern data to match the boundary of the first photoshoot region.

First, the first photoshoot region is assigned to the mask layout data that includes the first pattern data and the second pattern data (S10).

The mask layout data 100 may include data that becomes (e.g., forms) the basis for preparation of a mask that is used (utilized) in or during an exposure process.

In other words, the mask layout data 100 is data for designing the mask and may include various kinds of pattern data. That is, the mask that is actually used in the exposure process may be prepared on the basis of the mask layout data.

The mask layout data 100 may include various kinds of pattern data. The pattern data may be a plurality of design patterns included in the mask layout data 100. The design pattern may include variously shaped patterns. For example, the design pattern may include a line pattern, a contact pattern, a corner pattern, and/or a slot pattern. In another example embodiment, the design pattern may include any one of a triangle, a rectangle, a square, a parallelogram, a lozenge, a trapezoid, a semicircle, an ellipse, and a combination thereof.

However, the above-described design patterns are provided as examples, and the kinds of design patterns are not limited thereto.

The mask layout data 100 may include first pattern data 110 and second pattern data 120.

The first pattern data 110 is pattern data arranged in the mask layout data 100 and includes shape information of the design pattern.

The second pattern data 120 is pattern data arranged in the mask layout data 100 and includes shape information of the design pattern and array information. That is, the second pattern data 120 includes a repeated unit pattern 120a and array information about an arrangement of the repeated unit pattern 120a. In other words, the mask layout data 100 may include a plurality of design patterns that are repeated according to a specific rule or pattern, and when such design patterns form (e.g., are included in) the first pattern data as a whole (that is, when each of the repeated unit patterns is separately included in the mask layout data 100), the amount of data is considerably increased. Accordingly, in such a case, the data amount of the mask layout data 100 can be reduced by forming the second pattern data 120 such that it includes the repeating unit pattern 120a and the array information about the arrangement of the repeating unit pattern 120a.

In the mask layout data 100, an area occupied by the second pattern data 120 may be determined by the array information. That is, if the repeating unit pattern 120a is arranged with 3×4 array information (e.g., is arranged in a 3×4 array), the area that is occupied by the second pattern data 120 in the mask layout data 100 may be 12 times the area that is occupied by one repeating unit pattern 120a.

FIG. 2 illustrates example mask layout data 100.

As illustrated in FIG. 2, the mask layout data 100 may include at least one first pattern data 110 and at least one second pattern data 120. However, the pattern data illustrated in FIG. 2 is provided as an example, and the arrangement of the pattern data is not limited thereto. Further, the first pattern data 110 and the second pattern data 120 may be arranged to be spaced from (e.g., spaced apart from) each other or to be separated from each other but are not limited thereto. The first pattern data 110 and the second pattern data 120 may be arranged to overlap each other.

FIG. 3 schematically illustrates the second pattern data 120.

As illustrated in FIG. 3, the second pattern data 120 includes the repeated unit pattern 120a and array information. FIG. 3 illustrates that the repeated unit pattern 120a includes three design patterns. However, this is an example, and the repeated unit pattern 120a is not limited thereto. In another example embodiment, the repeated unit pattern 120a may be one pixel that includes RGB sub-pixels (e.g., red, green, and blue sub-pixels).

FIG. 3 also illustrates array information that is expressed in a matrix form (expressed as a 3×4 matrix in FIG. 3), but the array information is not limited thereto. That is, the array information may include various kinds of arrangement information.

FIG. 3 also illustrates that the repeated unit pattern 120a of the second pattern data 120 may be arranged according to the array information (e.g., in the 3×4 matrix). When the repeated unit pattern 120a is not displayed as a whole (e.g., does not form the first pattern data or is not individually stored) but is instead formed as (e.g., stored as) the repeated unit pattern 120a and the array information, the amount of data being used can be reduced.

A first photoshoot region P1 may be assigned to the mask layout data 100. In order to form a pattern on a panel, a plurality of photoshoots are performed while a mask and/or a panel is moved relative to the other during the exposure process. In general, the size of one photoshoot may be smaller than the mask. That is, in order to form a pattern on a panel, a plurality of photoshoots may be performed with respect to one or more masks.

In the description, the first photoshoot region P1 may refers to a region that is occupied by any one of the plurality of photoshoots. Further, the first photoshoot region P1 may be understood to include the pattern data of the mask layout data 100 that overlaps the first photoshoot region P1. That is, the first photoshoot region P1 may be a region that includes at least a part of the mask layout data 100. FIG. 2 illustrates that the first photoshoot region P1 is rectangular. However, this is an example, and the shape of the first photoshoot region P1 is not limited thereto.

In an example embodiment, the first photoshoot region P1 may be smaller than the mask layout data 100. That is, the first photoshoot region P1 may include a part of the mask layout data 100 (e.g., may include less than all of the mask layout data 100).

In an example embodiment, the mask layout data 100 may be mask layout data 100 that is designed using (utilizing) a stitch method. The stitch method is a design method to simplify duplicate patterns on the panel. That is, when a pattern is formed in the order of a-b-b-c on a panel, the mask layout data 100 using (utilizing) the stitch method may have a pattern of a-b-c. That is, the stitch method is a method for forming the a-b-b-c pattern on the panel by having only one of the duplicate b patterns and performing the photoshoot twice to duplicate the b pattern. That is, the exposure process is performed so that one photoshoot region includes a-b and another photoshoot region includes b-c, and when the exposure process is actually performed, the mask and/or panel is shifted (e.g., moved) in a direction (e.g., a horizontal direction) so that the b portions do not overlap each other to obtain the a-b-b-c pattern. Through the overlap design of the repeated patterns, the data amount of the mask layout data 100 can be reduced.

In the case of performing the design using the stitch method, the plurality of photoshoot regions that are assigned to the mask layout data may partially overlap each other. The details thereof will be further described later.

After assigning the first photoshoot region to the mask layout data including the first pattern data and the second pattern data (S10), it is determined whether or not a boundary of the first photoshoot region overlaps the second pattern data (S20).

In an example embodiment, when the first photoshoot region P1 is optionally assigned to the mask layout data 100 in which the first pattern data 110 and the second pattern data 120 are arranged, the boundary of the first photoshoot region P1 may overlap (e.g., may partially overlap) the second pattern data 120.

The determination of whether or not the boundary of the first photoshoot region P1 overlaps the second pattern data 120 (S20) is performed to determine whether or not the boundary of the first photoshoot region P1 crosses the second pattern data 120.

When the boundary of the first photoshoot region P1 does not overlap the second pattern data 120, the algorithm is ended or the next act (step) is performed. Although “end” is described in FIG. 1, this is an example, and the algorithm is not limited thereto. Another act (step) that is necessary for the photomask design method may then be performed. That is, the method for designing a photomask according to some embodiments of the present invention is not thereby limited but may be included in another method for designing a photomask as a part of the method for designing the photomask.

When the boundary of the first photoshoot region P1 extends over the second pattern data 120, the array information of the second pattern data is changed (S30) to match the boundary of the first photoshoot region P1.

For convenience in explanation, FIG. 3 is referred to. FIG. 3 illustrates an embodiment in which a boundary line I1 of the first photoshoot region P1 overlaps the second pattern data 120.

In the embodiment of the mask layout data 100 that is designed using the stitch method, when the data is not reconstructed on the basis of the photoshoot, it becomes difficult to compare a pattern that is actually formed on the panel with the mask layout data 100, and thus, it is difficult to find a design defect in the design stage. Accordingly, the data should be reconstructed on the basis of the photoshoot. For example, the second pattern data 120 includes the repeated unit pattern 120a and the array information, and in order to collect the data on the basis of the photoshoot, the array information should be reconstructed. That is, when the second pattern data 120 extends into (e.g., extends or crosses over the boundary of) the photoshoot region, the second pattern data 120 should be separated at (e.g., on the basis of) the boundary.

That is, the array information of the second pattern data 120 may be changed according to the location of (e.g., on the basis of) the boundary of the first photoshoot region P1 with respect to the second pattern data 120.

In other words, the array information may be changed on the basis of the area of the second pattern data 120 that is arranged on the inside of the first photoshoot region P1 and/or the area of the second pattern data 120 that is arranged on the outside of the second photoshoot region P1.

For this, the reconstructing the array information of the second pattern data to match the boundary of the first photoshoot region (S30) includes deriving corrected array information by determining (e.g., calculating) the array information that corresponds to the area of the second pattern data arranged on the inside of the first photoshoot region, and including the corrected array information in the pattern data of the first photoshoot region. In an example embodiment in which the boundary line I1 of the first photoshoot region P1 is between (e.g., discriminates) the second and third columns of the second pattern data 120 as shown in FIG. 3, the array information that corresponds to the area of the second pattern data 120 that is arranged on the inside of the first photoshoot region P1 is 2×4 (see FIG. 4). That is, the array information that corresponds to the area of the second pattern data 120 that is arranged on the inside of the first photoshoot region P1 may be array information which makes it possible to arrange the maximum number of repeated unit patterns 120a that can be accommodated in the area of the second pattern data 120 that is arranged on the inside of the first photoshoot region P1. That is, the corrected array information may be derived by calculating the maximum array information (that does extend out of the first photoshoot region P1) that can be accommodated in the area of the second pattern data 120 that is arranged on the inside of the first photoshoot region P1, and the corrected array information may be included in the pattern data of the first photoshoot region P1. In other words, the including of the corrected array information in the pattern data of the first photoshoot region P1 may be the including of the second pattern data that includes the corrected array information in the first photoshoot region P1. As described above, when the second pattern data 120 overlaps the boundary of the first photoshoot region P1, the pattern data included in the first photoshoot region P1 can be accurately determined (e.g., grasped) by deriving the corrected array information through calculation of the array information of the second pattern data 120 that is arranged on the inside of the first photoshoot region P1, and the corrected array information can be included in the pattern data of the first photoshoot region P1.

Hereinafter, other embodiments of the present invention will be described. In the following embodiments, the same reference numerals are used for the same configurations as those as described above, and the duplicate explanation thereof may be omitted or simplified.

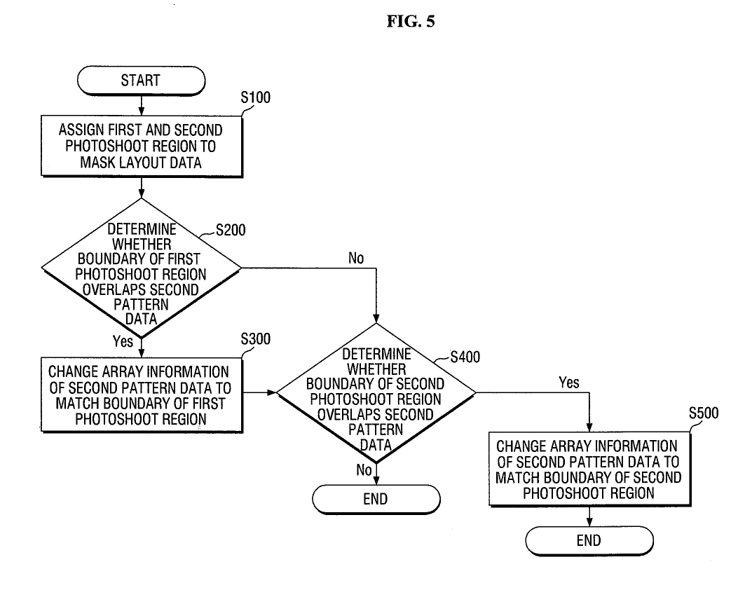

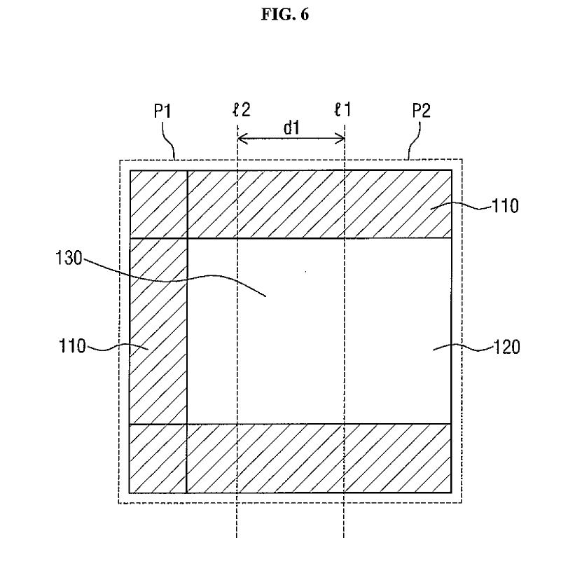

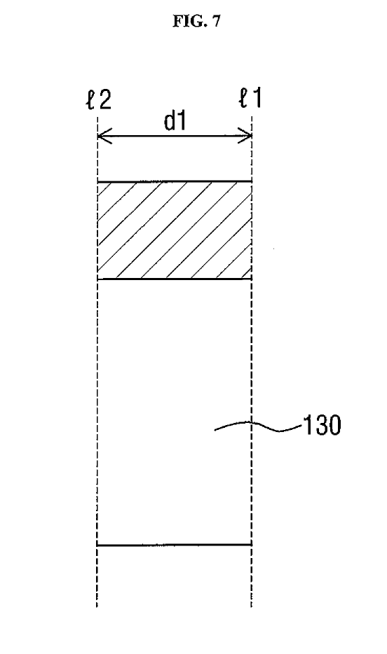

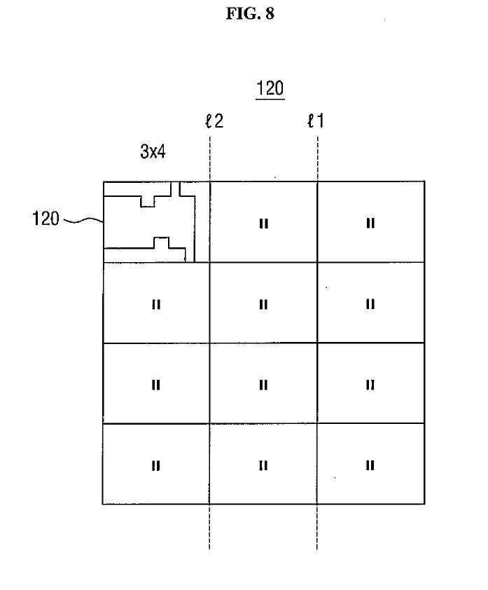

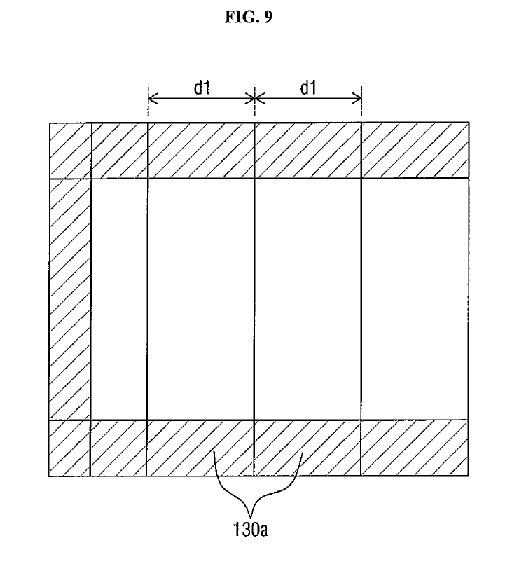

FIG. 5 is a flowchart of a method for designing a photomask according to another embodiment of the present invention. FIG. 6 is a schematic view of mask layout data that is used in a method for designing a photomask according to the embodiment shown in FIG. 5, FIG. 7 is a partial enlarged view of FIG. 6, and FIG. 8 is a partial enlarged view of FIG. 6. FIG. 9 is a schematic view illustrating a pattern that is actually formed on a panel on the basis of the mask layout data illustrated in FIG. 6.

Referring to FIGS. 5 to 8, a method for designing a photomask according to another embodiment of the present invention includes assigning a first photoshoot region and a second photoshoot region to mask layout data that includes first pattern data and second pattern data (S100), determining whether or not a boundary of the first photoshoot region overlaps the second pattern data (S200), reconstructing array information of the second pattern data to match the boundary of the first photoshoot region when the boundary of the first photoshoot region overlaps the second pattern data (S300), determining whether or not a boundary of the second photoshoot region overlaps the second pattern data (S400), and reconstructing the array information of the second pattern data to match the boundary of the second photoshoot region when the boundary of the second photoshoot region overlaps the second pattern data (S500).

First, the first photoshoot region and the second photoshoot region are assigned to the mask layout data that includes the first pattern data and the second pattern data (S100).

Because the first pattern data, the second pattern data, and the mask layout data are substantially the same as those as described above, the detailed explanation thereof may be omitted.

As described above, a plurality of photoshoots may be assigned to the mask layout data that is designed using the stitch method. Further, the plurality of photoshoots may partially overlap each other. Hereinafter, for convenience in explanation, it is described that the first photoshoot region and the second photoshoot region are assigned to the mask layout data that is designed using the stitch method. However, this is provided as an example, and the number of photoshoots is not limited thereto.

The first photoshoot region P1 and the second photoshoot region P2 may partially overlap each other. As illustrated in FIG. 6, the first photoshoot region P1 and the second photoshoot region P2 may include a region in which the first photoshoot region P1 and the second photoshoot region P2 overlap each other, that is, an overlap region 130.

As described above, the stitch method is a design method to simplify duplicate patterns on a panel. That is, when a pattern is formed in the pattern of a-b-b-c on a panel, the mask layout data 100 using the stitch method may have a pattern of a-b-c. That is, the stitch method relates to a method for forming the a-b-b-c pattern on the panel by having one b pattern and performing the photoshoot twice to duplicate the b pattern. That is, the exposure process is performed so that one photoshoot region includes a-b and another photoshoot region includes b-c, and when the exposure process is performed, the mask and/or panel is shifted (e.g., moved) by a first distance dl in a direction (e.g., a horizontal direction) so that the b portions do not overlap each other to obtain the a-b-b-c pattern. By designing the duplicate patterns as one pattern (e.g., by designing and/or storing the duplicate patterns only once), the data amount of the mask layout data 100 can be reduced.

When performing the design using the stitch method, the plurality of photoshoot regions that are assigned to the mask layout data may partially overlap each other.

In other words, when forming the pattern on the panel on the basis of the mask layout data 100 that is designed using the stitch method, a pattern 130a that corresponds to the overlap region 130 may be repeatedly arranged on the panel. That is, as illustrated in FIG. 9, the patterns 130a that correspond to the overlap region 130 may be arranged to be adjacent to each other by the first photoshoot and the second photoshoot.

Then, it is determined whether or not the boundary of the first photoshoot region overlaps the second pattern data (S200).

When the first photoshoot region P1 is optionally assigned to the mask layout data 100 in which the first pattern data 110 and the second pattern data 120 are arranged, the boundary of the first photoshoot region P1 may overlap the second pattern data 120.

When the boundary of the first photoshoot region P1 does not overlap the second pattern data 120, it may be determined whether or not the boundary of the second photoshoot region P2 overlaps the second pattern data (S400). This will be described in further detail later.

When the boundary of the first photoshoot region P1 overlaps the second pattern data 120, the array information of the second pattern data is reconstructed (S300) to match the boundary of the first photoshoot region P1.

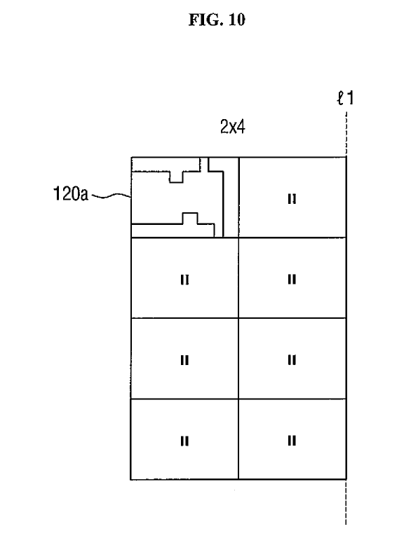

For convenience in explanation, FIGS. 8 and 10 are referred to. FIG. 10 is a schematic view illustrating the reconstructed second pattern data shown in FIG. 8 to match the boundary of the first photoshoot region P1.

FIG. 8 illustrates a case where the second pattern data 120 overlaps the boundary line I1 of the first photoshoot region P1.

In the case of the mask layout data 100 that is designed using the stitch method, when the data is not reconstructed on the basis of the photoshoot, it becomes difficult to compare a pattern that is actually formed on the panel with the mask layout data 100, and thus, it is difficult to find a design defect in the design stage. Accordingly, it is necessary to reconstruct the data on the basis of the photoshoot. For example, the second pattern data 120 includes the repeated unit pattern 120a and the array information, and in order to collect the data on the basis of the photoshoot, the array information should be reconstructed. That is, when the second pattern data 120 overlaps the boundary of one or more photoshoot regions, the second pattern data 120 should be separated on the basis of the boundary.

In an example embodiment, the array information may be changed on the basis of the area of the second pattern data 120 that is arranged on the inside of the first photoshoot region P1 and/or the area of the second pattern data 120 that is arranged on the outside of the first photoshoot region P1.

For this, the reconstructing the array information of the second pattern data to match the boundary of the first photoshoot region (S300) may include deriving corrected array information by determining (e.g., calculating) the array information that corresponds to the area of the second pattern data that is arranged on the inside of the first photoshoot region, and the corrected array information can be included in the pattern data of the first photoshoot region.

In an example embodiment, the calculating of the array information that corresponds to the area of the second pattern data 120 that is arranged on the inside of the first photoshoot region P1 may calculate the array information which makes it possible to arrange the maximum number of repeated unit patterns 120a in the area of the second pattern data 120 that is arranged on the inside of the first photoshoot region P1. That is, in an example embodiment in which the boundary line I1 of the first photoshoot region P1 is between (e.g., discriminates) the second and third columns of the second pattern data 120 as shown in FIG. 8, the array information which makes it possible to arrange the maximum number of repeated unit patterns 120a in the area of the second pattern data 120 that is arranged on the inside of the first photoshoot region P1 is 2×4 (see FIG. 10).

That is, the array information that corresponds to the area of the second pattern data 120 that is arranged on the inside of the first photoshoot region P1 may be array information which makes it possible to arrange the maximum number of repeated unit patterns 120a in the area of the second pattern data 120 that is arranged on the inside of the first photoshoot region P1.

In other words, the corrected array information may be derived by calculating the maximum array information (that does not extend out of the first photoshoot region P1) that can be accommodated in the area of the second pattern data 120 that is arranged on the inside of the first photoshoot region P1, and the corrected array information may be included in the pattern data of the first photoshoot region P1. In other words, the including of the corrected array information in the pattern data of the first photoshoot region P1 may be the of including the second pattern data that includes the corrected array information in the first photoshoot region P1.

As described above, when the second pattern data 120 overlaps the boundary of the first photoshoot region P1, the pattern data included in the first photoshoot region P1 can be accurately determined (e.g., grasped) by deriving the corrected array information through calculation of the array information that corresponds to the area of the second pattern data 120 that is arranged on the inside of the first photoshoot region P1, and including the second pattern data 120 that includes the corrected array information in the pattern data of the first photoshoot region P1. That is, the pattern data of the mask layout data 100 can be accurately grasped on the basis of the photoshoot.

When the boundary of the first photoshoot region P1 does not overlap the second pattern data 120 or after the array information of the second pattern data 120 is reconstructed to match the boundary of the first photoshoot region P1, it is determined whether or not the boundary of the second photoshoot region P2 overlaps the second pattern data 120 (S400).

The determining of whether or not the boundary of the second photoshoot region P2 overlaps the second pattern data 120 (S400) may be substantially the same as the determining of whether or not the boundary of the first photoshoot region P1 overlaps the second pattern data (S200).

When the second photoshoot region P2 is optionally assigned to the mask layout data 100 in which the first pattern data 110 and the second pattern data 120 are arranged, the boundary of the second photoshoot region P2 may overlap the second pattern data 120.

When the boundary of the second photoshoot region P2 does not overlap the second pattern data 120, the algorithm may be ended or another act (step) may be performed.

When the boundary of the second photoshoot region P2 overlaps the second pattern data 120, the array information of the second pattern data is reconstructed (S500) to match the boundary of the second photoshoot region P2.

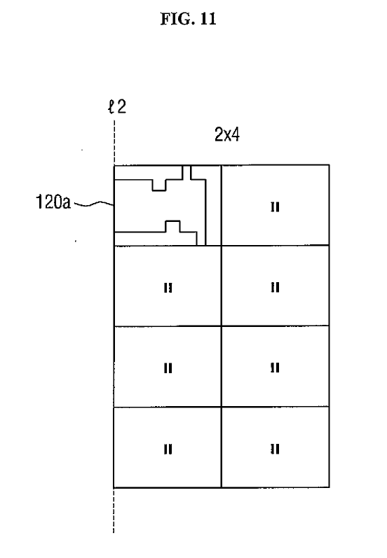

The reconstructing of the array information of the second pattern data to match the boundary of the second photoshoot region P2 (S500) may be substantially the same as the reconstructing of the array information of the second pattern data to match the boundary of the first photoshoot region P1 (S300). For convenience in explanation, FIGS. 8 and 11 are referred to.

FIG. 11 is a schematic view illustrating the reconstructed second pattern data 120 shown in FIG. 8 to match the boundary of the second photoshoot region P2.

FIG. 8 illustrates a case in which the second pattern data 120 overlaps the boundary line I2 of the second photoshoot region P2.

In an example embodiment, the array information may be changed on the basis of the area of the second pattern data 120 that is arranged on the inside of the second photoshoot region P2 and/or the area of the second pattern data 120 that is arranged on the outside of the second photoshoot region P2.

For this, the reconstructing of the array information of the second pattern data to match the boundary of the second photoshoot region (S500) may include deriving corrected array information by calculating the array information that corresponds to the area of the second pattern data that is arranged on the inside of the second photoshoot region, and the corrected array information can be included in the pattern data of the second photoshoot region.

In an example embodiment, the calculating the array information that corresponds to the area of the second pattern data 120 that is arranged on the inside of the second photoshoot region P2 may calculate the array information which makes it possible to arrange the maximum number of repeated unit patterns 120a that can be accommodated in the area of the second pattern data 120 that is arranged on the inside of the second photoshoot region P2. That is, in an example embodiment in which the boundary line I2 of the second photoshoot region P2 discriminates the first and second columns of the second pattern data 120 as shown in FIG. 8, the array information which makes it possible to arrange the maximum number of repeated unit patterns 120a in the area of the second pattern data 120 that is arranged on the inside of the second photoshoot region P2 is 2×4.

That is, the array information that corresponds to the area of the second pattern data 120 that is arranged on the inside of the second photoshoot region P2 may be array information which makes it possible to arrange the maximum number of repeated unit patterns 120a in the area of the second pattern data 120 that is arranged on the inside of the second photoshoot region P2.

In other words, the corrected array information may be derived by calculating the maximum array information (that does not extend out of the second photoshoot region P2) that can be accommodated in the area of the second pattern data 120 that is arranged on the inside of the second photoshoot region P2, and the corrected array information may be included in the data of the second photoshoot region P2. In other words, the including of the corrected array information in the pattern data of the second photoshoot region P2 may be the including of the second pattern data that includes the corrected array information in the second photoshoot region P2.

As described above, when the second pattern data 120 overlaps the boundary of the second photoshoot region P2, the pattern data included in the second photoshoot region P2 can be accurately grasped by deriving the corrected array information through calculation of the array information that corresponds to the area of the second pattern data 120 that is arranged on the inside of the second photoshoot region P2, and the second pattern data 120 that includes the corrected array information can be included in the pattern data of the second photoshoot region P2. That is, the pattern data of the mask layout data 100 can be accurately grasped on the basis of the photoshoot.

When the boundary of the second photoshoot region P2 overlaps the second pattern data 120, the algorithm may be ended or another act may be performed after the array information of the second pattern data is reconstructed to match the boundary of the second photoshoot region P2 as described above.

The method for designing the photomask according to another embodiment of the present invention may include enumerating pattern data of the first photoshoot region and pattern data of the second photoshoot region so that the pattern data do not overlap each other.

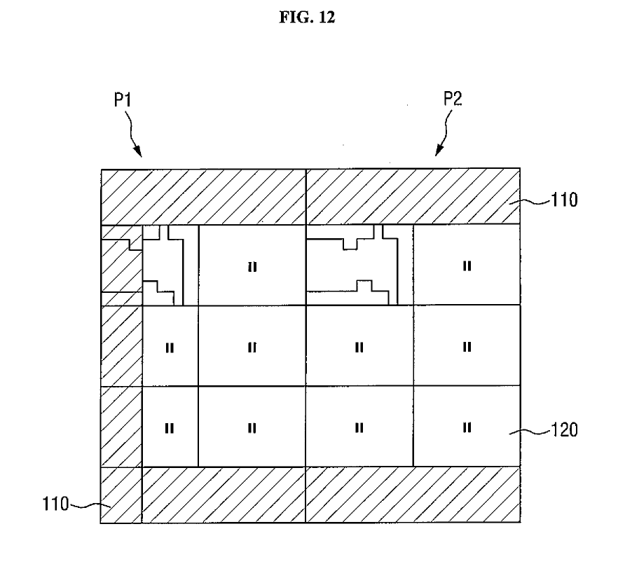

FIG. 12 is a schematic view illustrating an enumeration of pattern data of the first photoshoot region and pattern data of the second photoshoot region so that the respective pattern data does not overlap each other.

Referring to FIG. 12, the pattern data of the first photoshoot region P1 and the pattern data of the second photoshoot region P2, which are acquired through reconstruction of the second pattern data, may be enumerated so that the respective pattern data does not overlap each other.

As described above, when the pattern data of the first photoshoot region P1 and the pattern data of the second photoshoot region P2 are enumerated without overlapping, it becomes possible to compare the pattern that is actually formed on the panel (see FIG. 9) with design data, that is, the mask layout data, using the enumerated pattern data (e.g., without actually forming the pattern on a panel). Through this, a design defect of the mask layout data can be found in advance in the design stage and the corresponding measures can be taken.

The method for designing the photomask according to some embodiments of the present invention as described above may be included in a design program and may be performed by a computer. Further, the above-described design program may be stored in a computer-readable recording medium.

In other words, a computer-readable recording medium according to an embodiment of the present invention is a computer-readable recording medium recorded with (e.g., storing) the design program of the photomask, and the design program that is performed by a computer includes assigning a first photoshoot region to mask layout data that includes first pattern data and second pattern data, determining whether or not a boundary of the first photoshoot region overlaps the second pattern data, and reconstructing array information of the second pattern data to match the boundary of the first photoshoot region.

A computer-readable recording medium according to another embodiment of the present invention is a computer-readable recording medium storing (recorded with) the design program of the photomask, and the design program that is performed by a computer includes assigning a first photoshoot region and a second photoshoot region to mask layout data including first pattern data and second pattern data (S100), determining whether or not a boundary of the first photoshoot region overlaps the second pattern data (S200), reconstructing array information of the second pattern data to match the boundary of the first photoshoot region when the boundary of the first photoshoot region overlaps the second pattern data (S300), determining whether or not a boundary of the second photoshoot region overlaps the second pattern data (S400), and reconstructing the array information of the second pattern data to match the boundary of the second photoshoot region when the boundary of the second photoshoot region overlaps the second pattern data (S500).

Because the respective steps are substantially the same as those in the method for designing the photomask according to some embodiments of the present invention as described above, the detailed explanation thereof may be omitted.

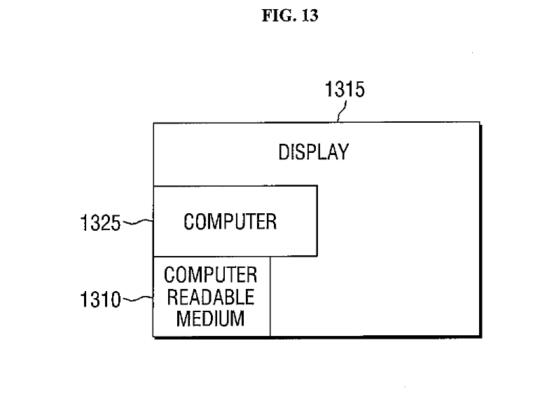

FIG. 13 shows an example of a computer 1325 constructed in a display 1315 according to an embodiment of the present invention. Here, a program (e.g., a design program) as described above is stored in a computer-readable recording medium 1310 and causes the computer 1325 in the display 1315 to perform a process for designing a photomask as described above. Here, the term “computer” is used herein to include any combination of hardware employed to process data or digital signals. Computer hardware may include, for example, application specific integrated circuits (ASICs), general purpose or special purpose central processing units (CPUs), digital signal processors (DSPs), graphics processing units (CPUs), and programmable logic devices such as field programmable gate arrays (FPGAs).

Although example embodiments of the present invention have been described for illustrative purposes, those skilled in the art will appreciate that various modifications, additions, and substitutions are possible, without departing from the scope and spirit of the invention as disclosed in the accompanying claims and their equivalents.

What is claimed is:

1. A method for designing a photomask, the method comprising:
preparing mask layout data comprising first pattern data and second pattern data, the first pattern data comprising shape information of a design pattern, and the second pattern data comprising the shape information of the design pattern and array information;
assigning a first photoshoot region to the mask layout data;
determining whether or not the first photoshoot region overlaps the second pattern data; and
when the first photoshoot region overlaps the second pattern data, reconstructing the second pattern data according to a boundary of the first photoshoot region.

2. The method of claim 1, wherein the second pattern data further comprises repeated unit patterns arranged according to the array information.

3. The method of claim 1, wherein the array information comprises arrangement information in a matrix form.

4. The method of claim 1, wherein the mask layout data is designed utilizing a stitch method.

5. The method of claim 1, wherein the reconstructing of the second pattern data comprises:
deriving corrected array information by determining the array information of the second pattern data that is in the first photoshoot region; and
including the corrected array information in the second pattern data in the first photoshoot region.

6. The method of claim 5, wherein the corrected array information is array information which allows a maximum number of repeated unit patterns of the second pattern data to be in the first photoshoot region.

7. A method for designing a photomask, the method comprising:
assigning a first photoshoot region and a second photoshoot region to mask layout data, the mask layout data comprising first pattern data and second pattern data;
determining whether or not the first photoshoot region overlaps the second pattern data;
when the first photoshoot region overlaps the second pattern data, reconstructing array information of the second pattern data according to a boundary of the first photoshoot region;
determining whether or not the second photoshoot region overlaps the second pattern data; and
when the boundary of the second photoshoot region overlaps the second pattern data, reconstructing the array information of the second pattern data according to a boundary of the second photoshoot region.

8. The method of claim 7, wherein the second pattern data further comprises repeated unit patterns arranged according to the array information.

9. The method of claim 7, wherein the array information comprises arrangement information in a matrix form.

10. The method of claim 7, wherein the mask layout data is designed utilizing a stitch method.

11. The method of claim 7, wherein the reconstructing of the array information of the second pattern data comprises deriving corrected array information by determining the array information of the second pattern data that is in the first photoshoot region, and including the corrected array information in the second pattern data in the first photoshoot region, and
the reconstructing the array information of the second pattern data comprises deriving the corrected array information by determining the array information of the second pattern data that is in the second photoshoot region, and including the corrected array information in the second pattern data in the second photoshoot region.

12. The method of claim 7, further comprising enumerating the second pattern data in the first photoshoot region and the second pattern data in the second photoshoot region so that respective pattern data does not overlap each other.

13. A computer-readable recording medium storing a design program of a photomask, the design program being for causing a computer to perform a process comprising:
assigning a first photoshoot region to mask layout data, the mask layout data comprising first pattern data and second pattern data;
determining whether or not the first photoshoot region overlaps the second pattern data; and
when the first photoshoot region overlaps the second pattern data, reconstructing the second pattern data according to a boundary of the first photoshoot region.

14. The computer-readable recording medium of claim 13, wherein the reconstructing of the second pattern data comprises:
deriving corrected array information by determining the array information of the second pattern data that is in the first photoshoot region; and
including the corrected array information in the pattern data in the first photoshoot region.

15. The computer-readable recording medium of claim 14, wherein the corrected array information is array information which allows a maximum number of repeated unit patterns of the second pattern data to be arranged in the first photoshoot region.

16. A computer-readable recording medium storing a design program of a photomask, the design program being for causing a computer to perform a process comprising:
assigning a first photoshoot region and a second photoshoot region to mask layout data, the mask layout data comprising first pattern data and second pattern data;
determining whether or not the first photoshoot region overlaps the second pattern data;
when the first photoshoot region overlaps the second pattern data, reconstructing array information of the second pattern data according to a boundary of the first photoshoot region;
determining whether or not the second photoshoot region overlaps the second pattern data; and
when the second photoshoot region overlaps the second pattern data, reconstructing the array information of the second pattern data according to a boundary of the second photoshoot region.

17. The computer-readable recording medium of claim 16, wherein the reconstructing of the second pattern data comprises:
deriving corrected array information by determining the array information of the second pattern data that is in the first photoshoot region; and
including the corrected array information in the second pattern data in the first photoshoot region.

18. The computer-readable recording medium of claim 17, wherein the corrected array information is array information which allows a maximum number of repeated unit patterns of the second pattern data to be in the first photoshoot region.
